(19) United States
(12) Patent Application Publication
(10) Pub. No.: US 2016/0176554 A1
(43) Pub. Date: Jun. 23, 2016

(54) PACKAGED BAKED FOOD ITEM AND METHOD

(71) Applicant: KRAFT FOODS R & D, INC., Deerfield, IL (US)

(72) Inventors: John Blake, East Hanover, NJ (US); Ying (Lora) Liang, Deerfield, IL (US); Michele Wright, East Hanover, NJ (US); Odette Moncayo, Whippany, NJ (US)

(73) Assignee: KRAFT FOODS R & D, INC., Deerfield, IL (US)

(21) Appl. No.: 14/910,386

(22) PCT Filed: Jul. 23, 2014
(86) PCT No.: PCT/IB2014/063329

§ 371 Date: Feb. 5, 2016

(30) Foreign Application Priority Data
Aug. 7, 2013 (GB) 1314110.6

(51) Int. Cl. B65B 25/16; B65B 47/10; B65D 77/02; A21D 13/08; B65D 81/34

(52) U.S. Cl. CPC B65B 25/16; A21D 13/08; B65D 81/343; B65D 77/02; B65B 47/10

(57) ABSTRACT

A packaged baked food item, and a method for forming it, are disclosed. A film is laid over a tray containing moulds and a portion of dough deposited onto the film over each mould. The dough is baked to form an item having a face moulded by the inner surface of the mould and with the film conformed to it. A second film is extended over the first film and the films attached to each other to at least partially enclose the baked food item between the first and second films as a package. The first film may be pre-formed to the shape of the moulds prior to depositing the dough and baking. The method provides a means to facilitate packaging baked items, with a package mimicking the moulded shape of the underlying item, and may also be used to reduce the need for resurfacing of baking trays with non-stick layers.

The present invention relates to a packaged baked food item and a method for producing a packaged baked food item.

Typically, a baked food item such as a biscuit or cake or similar, may be formed by baking a dough or batter in a mould. The baked food item is then removed from the mould as a solid product for subsequent wrapping or packaging. Wrapping subsequently applied to the food item may be made to at least partially conform to a shape of the item, for example for functional or aesthetic packaging reasons. In order to conform the wrapper closely to the shape of the food item, heat and/or pressure may be applied to the packaging material in such methods.

A disadvantage of such processes for conforming a package to a baked food item is that the application of heat and/or pressure on the packaging on the item may have a negative effect on the underlying baked food item to which the wrapper is to be conformed. For instance, the heat and/or pressure may change a shape, or consistency, or quality, or the like of the food item in an undesired manner.

Hence, there is a need for methods and packages to permit a baked food item to be wrapped in a package which closely conforms to at least a portion of the food item without the formation of the resulting packaged food item causing problems to the characteristics of the underlying packaged food product.

Furthermore, the moulds used for preparing baked food items in an industrial process may deteriorate rapidly over time, leading to the need for the resurfacing of the moulds with non-stick coatings or regular application of non-stick material to the moulds prior to use in order to reduce or inhibit adhesion of the baked food items to the moulds following baking. This may lead to a need for a surplus of moulds being required, with some moulds in use whilst others are temporarily decommissioned for re-application of a non-stick coating. This adds to the complexity and cost of the production of the baked food items.

It is one aim of exemplary embodiments of the present invention, amongst others, to provide a packaged food item which at least partially obviates or mitigates at least some of the disadvantages of the prior art, whether identified herein or elsewhere. For instance, it is an aim of exemplary embodiments of the invention to provide a packaged baked food item wherein the packaging conforms to the shape of at least a portion of the surface of the food item so that the appearance of at least that portion the packaged food item is evident, upon viewing the packaged food item, from the shape of the conformed packaging. It is a further aim of exemplary embodiments of the invention to provide a method for producing packaged baked food items which reduces or removes the need for re-surfacing of moulds prior to baking.

According to the present invention there is provided an apparatus and method as set forth in the appended claims. Other features of the invention will be apparent from the dependent claims, and the description which follows.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention. Typically, when referring to compositions, a composition consisting essentially of a set of components will comprise less than 5% by weight, typically less than 3% by weight, more typically less than 1% by weight of non-specified components.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each exemplary embodiment of the invention, as set out herein are also applicable to any other aspects or exemplary embodiments of the invention, where appropriate. In other words, the skilled person reading this specification should consider the optional features for each exemplary embodiment of the invention as interchangeable and combinable between different exemplary embodiments.

An exemplary embodiment of the present invention provides a method of forming a packaged baked food item, the method comprising:
providing a tray comprising a mould,
providing a first film extending over the tray and mould,
depositing an aliquot of dough onto the first film extending over the mould,
baking the aliquot of dough to provide a baked food item having a moulded face with the first film conformed thereto, wherein a portion of the dough forming the moulded face and the first film conform to an inner face of the mould, and
providing a second film extending over the baked food item and the first film, and attaching the second film to the first film to at least partially enclose the aliquot of dough between the first and second films as the packaged baked food item.

The attaching of the second film to the first film to at least partially enclose the aliquot of dough between the first and second films may be carried out prior to baking the aliquot of dough to provide the baked food item. The attaching of the second film to the first film to at least partially enclose the aliquot of dough between the first and second films may be carried out after baking the aliquot of dough to provide the baked food item.

The second film may be attached to the first film in order to fully enclose the baked food item between the first and second films.

The baked food item may be a sweet or a savoury food item, such as a biscuit or a cake. The use of the term “dough” is meant to include both doughs and batters which may be either solid or liquid in nature at room temperature (say 20° C. to 30° C.) but which are flowable into a mould at higher temperatures (say 100° C. or higher) so that they may conform to the shape of a mould prior to being baked to transform into a solid baked food item capable of self-support under gravity.

Although reference may be made herein to a mould in the singular, it is to be understood that for exemplary embodiments of the invention, the term mould may also be used in the singular but may refer to either a single mould or to each mould of a plurality of moulds contained within a tray.

In the following description, it is assumed that the tray comprising the mould or moulds is to be held with its upper surface horizontal and with the mould or moulds as recesses in the tray oriented for filling from above. It will be understood that the tray may be held approximately horizontally (say within a few degrees of horizontal, such as +/−5° until the dough is baked to form a solid food item, and that once the dough has been baked to form a solid food item, the horizontal, or near horizontal, orientation of the upper surface of the tray is less important.

An aliquot of dough is deposited onto the first film extending over the mould. Typically, the first film may be a relatively thin film and may yield somewhat under the weight of the dough to form a recess or concave dish shape to hold the dough positioned over the mould. The dough aliquot will suitably be of a size in order to fill the mould to the level of the upper surface of the tray once the dough becomes flowable, if it is not already flowable at deposition.

The dough is then heated for baking, and this may be achieved, for instance, by placing the tray in an oven. This may be a hot air oven or a microwave oven, for instance. As a result of the heating required for baking, typically at a temperature (or over a range of temperatures) from say 150° C. to 250° C., the first film may soften and may be pushed into the mould under the weight of the flowable dough. This results in the dough aliquot pushing the first film into the inner face of the mould to conform to the inner face of the mould, with the lower portion of the dough aliquot also conformed to the inner face of the mould (through the first film) when the baking process takes place, solidifying the dough into a solid baked food item, the portion of the dough forming the moulded face of the baked food item and the first film in contact therewith both conform to an inner face of the mould. It will be understood that the first film and the moulded face of the baked food item may not conform exactly to the inner face of the mould, but will substantially achieve conformation depending upon the extent to which the weight of the dough is capable of pushing the first film into conformity with the inner face of the mould.

The method of this exemplary embodiment then provides a second film extending over the tray, the mould, the baked food item and the first film, and attaching the second film to the first film to enclose the baked food item between the first and second films. As explained above, the baked food item may be of a size such that it fills the mould, including the first film in the mould, so that when the second film is placed over the baked food item, there is little or no free space left remaining between the first and second films enclosing the baked food item. In an exemplary embodiment, the baked food item may overfill the mould so that its upper, freely-baked surface which solidified by baking, not in direct contact with the mould, stands proud of the upper surface of the tray covered in first film. The extent of fill, underfill or overfill of the mould may be determined by the size of the aliquot of dough used.

As already explained hereinbefore, the tray may comprise a plurality of moulds and an aliquot of dough may be deposited onto each mould for forming a plurality of packaged baked food items.

In an exemplary embodiment of the invention, the method may provide a plurality of packaged baked food items in a multipack arrangement, wherein the multipack arrangement comprises the packaged baked food items mutually interconnected by flanges formed where the first and second films are attached together. For this exemplary embodiment, the method of the invention may further comprise providing lines of weakness between the packaged food items, whereby the packaged baked food items may be separated from the multipack arrangement.

The method of the exemplary embodiment may alternatively further comprise separating the packaged baked food items from the multipack arrangement by forming cuts between the packaged baked food items along the interconnecting flanges.

The tray used in the methods of the invention may comprises a flat upper surface having the mould (or moulds) as a recess (recesses) therein.

The first and second films may be attached together by pressing the second film against the first film at loci where the first film is supported by the flat upper surface of the tray. In other words, the flat upper surface of the tray, at locations between individual moulds, may be used as an anvil or surface against which portions of the first and second films may be pressed together whilst being attached to each other. Attachment may be effected by any suitable means, such as by providing pressure sensitive adhesive at locations between the films, or, for instance, by thermal or melt welding of the films. The first and second films may be peelably attached together, giving the benefit of facilitating the opening of the package containing the baked food item by a user being able to peel the first and second films apart. The first and second films may be attached sporadically around a perimeter, or may be sealed together, for instance to provide a hermetic seal which is resistant to the passage of air or water vapour or liquid moisture between the contents of the package and the surroundings of the package.

The first film may be a thermoformable film, which is deformable to conform to the inner face of the mould at the baking temperature. This means that the film may become substantially more deformable at an elevated temperature than it is at room temperature. For such films, their behaviour may be defined by a glass transition temperature for the thermoformable film, wherein the glass transition temperature is lower than a temperature at which baking the dough aliquot takes place. The thermoformable film is highly deformable at temperatures in excess of the glass transition temperature. The glass transition temperature for a polymer may be measured, for instance, using DSC (differential scanning calorimetry) using conventional methods.

The glass transition temperature may be in excess of 30° C., optionally in excess of 50° C., so that the first film may not be substantially deformable at room temperature, but may be highly deformable at temperatures of 100° C. or more such as at the baking temperature, which may, for instance, be at a temperature, or range of temperatures, from say 150° C. to 250° C.

In one exemplary embodiment of the invention, the first film may be conformed to the inner face of the mould prior to depositing the aliquot of dough into the mould. This is as an alternative to using the weight of the dough, acting under gravity, and pushing the first film into the inner face of the mould as set out hereinbefore.

For instance, the first film may be conformed to the inner face of the mould by vacuum forming the first film prior to depositing the aliquot of dough into the mould. This may be achieved, for instance, by providing the tray with a plurality of fine apertures extending through the body of the tray, providing the first film extending over the upper surface of the tray and heating the tray and first film to a temperature in excess of a glass transition temperature for the first film. A reduced pressure may then be applied to the lower face of the tray, using a vacuum pump or the like, to withdraw air from a region between the first film and the tray, so that the first film is conformed to the shape of the upper surface of the tray, including the inner faces of the mould(s). For this exemplary embodiment, the first film may be already conformed to the shape of the inner face of the mould prior to deposition of the dough aliquot into the mould, and this may result in improved conformation of the first film, and the moulded face of the dough aliquot, to each other and to the inner face of the mould

The first film may be a multilayer film comprising at least an inner layer in contact with the baked food item and an outer layer in contact with the tray. The inner layer may be of a first material compatible with food contact at the baking temperature, and the outer layer may be of a second material suitable as an external barrier layer. The inner layer preferably includes only low levels of components which may migrate it to the food item during the baking process, more preferably being free of such components.

For instance the inner layer may be of a material such as polyethylene terephthalate or, for instance a nylon such as a PA12/PA612 blend. Preferably, the outer layer is layer of a material which has a low tendency to adhere to the material of the upper surface of the tray. The outer layer may be of a material such as nylon PA66, PA66 or a blend thereof or polypropylene with a PTFE coating to aid in preventing adhesion to the tray. The first film as a multilayer film may include a metal foil layer as an interlayer or as an outer layer, for instance an aluminium foil layer.

The outer layer may be a printed outer layer, printed prior to providing the first film extending over the tray and mould. The printed layer may be a graphic or decorative layer. The decoration may be applied to the film as a flat film, with the printing taking into account the expected subsequent distortion of the first film when the first film is deformed to conform to the inner face of the mould. In other words, the desired image may be printed as a distorted image on the flat first film, becoming the desired image after the first film has been conformed to the shape of the inner face of the mould. The second film may also be pre-printed film or it may be that the second film is a pre-printed film and the first film is not pre-printed. The printing may be on the face of the second film which is not in contact with the baked food item.

The first film may have a substantially uniform thickness of less than 0.2 mm. This thickness constraint may also apply to the second film.

The first film may adapted to shrink following baking of the dough, whereby the baked food item is tightly enclosed between the first and second films.

Thus an exemplary embodiment of the invention provides a method of forming a packaged baked food item, the method comprising:
providing a tray comprising a mould,
providing a first film extending over the tray and mould,
conforming the first film to an inner face of the mould by vacuum moulding,
depositing an aliquot of dough onto the first film conformed to the inner face of the mould,
baking the dough aliquot to provide a baked food item having a moulded face conformed to the first film within the mould and the inner face of the mould, and
providing a second film extending over the tray, the mould, the baked food item and the first film, and attaching the second film to the first film to enclose the aliquot of dough between the first and second films as the packaged baked food item.

An exemplary embodiment of the invention provides a packaged food item comprising a package having an enclosure adapted to hold the food item, wherein the package comprises:
a first package part comprising a receptacle having an opening comprising a material adapted to withstand a process for baking the food item and
a second package part attached to the first package part,
wherein the enclosure is at least partially formed via an association between the first and second package parts, and
wherein the receptacle includes an inner face adapted to conform to a shaped portion of a surface of the food item. For instance, the first package part may be adapted to withstand a baking temperature in the range 150 to 250° C. (i.e. from 150 to 250° C.), whereby the food item may be baked in the first package part, for instance as set out hereinbefore.

The enclosure may be entirely formed via an association between the first and second package parts.

The opening of the receptacle may have a flange extending at least partially around the opening, and the second package part may be attached to the flange.

The receptacle may include an outer face following the shape of the inner face.

The first and/or second package parts may be formed of a plastically deformable material whereby the package may be manually compacted for disposal following removal from the food item

The packaged baked food item of this exemplary embodiment may be obtained or obtainable by the methods of the invention, such as the methods of the exemplary embodiments of the invention as set out hereinbefore, wherein the first package part is formed from the first film and the second packaged part is formed from the second film.

Thus, exemplary embodiments of the invention provide the technical benefit that the food item is securely retainable in contact with, and optionally mated with, the inner face of the receptacle within the package, with the outer face of the receptacle potentially providing, to a viewer of the package, a clear display of the shape of the food item retained therein by means of the visible shape of the outer face of the receptacle. This may be used to permit any display, graphics or text, which may be present in relief form on the surface of the product, to be visible on the outer face of the receptacle of the package, also in relief form, irrespective of any additional information or display printed on the outer face of the receptacle of the package. This is achieved without the need to apply pressure or heat to conform the package to the shaped portion of the packaged baked food item after the initial baking of the food item.

The shaped portion of the surface of the food item may represent at least 30% of the total surface area of the item, for instance at least 40%, such as at least 50% or at least 60%.

For a better understanding of the invention, and to show how exemplary embodiments of the same may be carried into effect, reference will be made, by way of example only, to the accompanying diagrammatic Figures, in which:

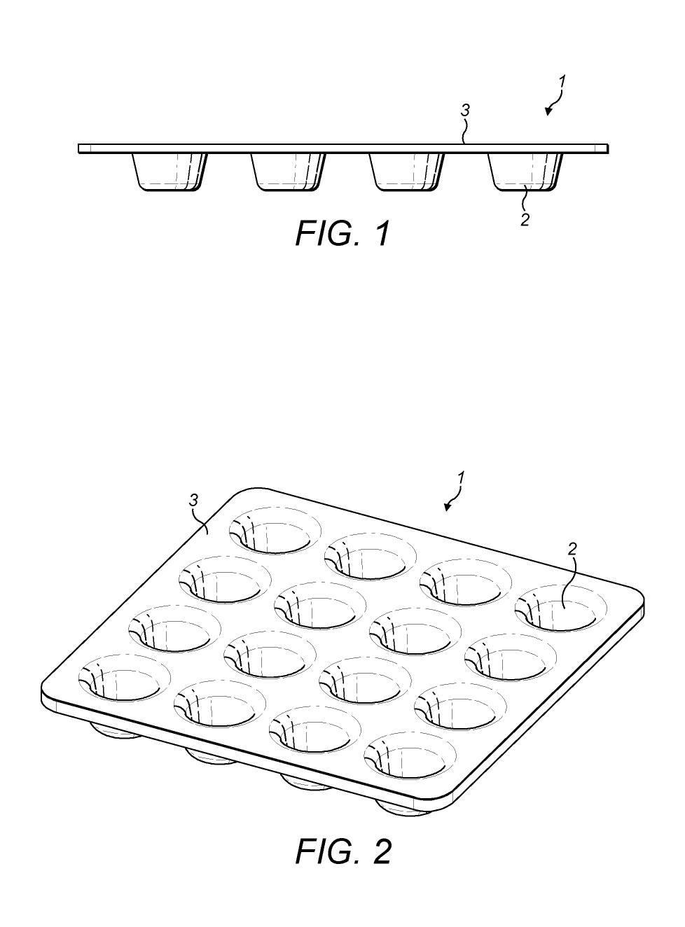

FIG. 1 schematically depicts a side view of a tray suitable for use in embodiments of methods according to the invention;

FIG. 2 schematically depicts a top perspective view of the tray suitable for use in embodiments of methods according to the invention;

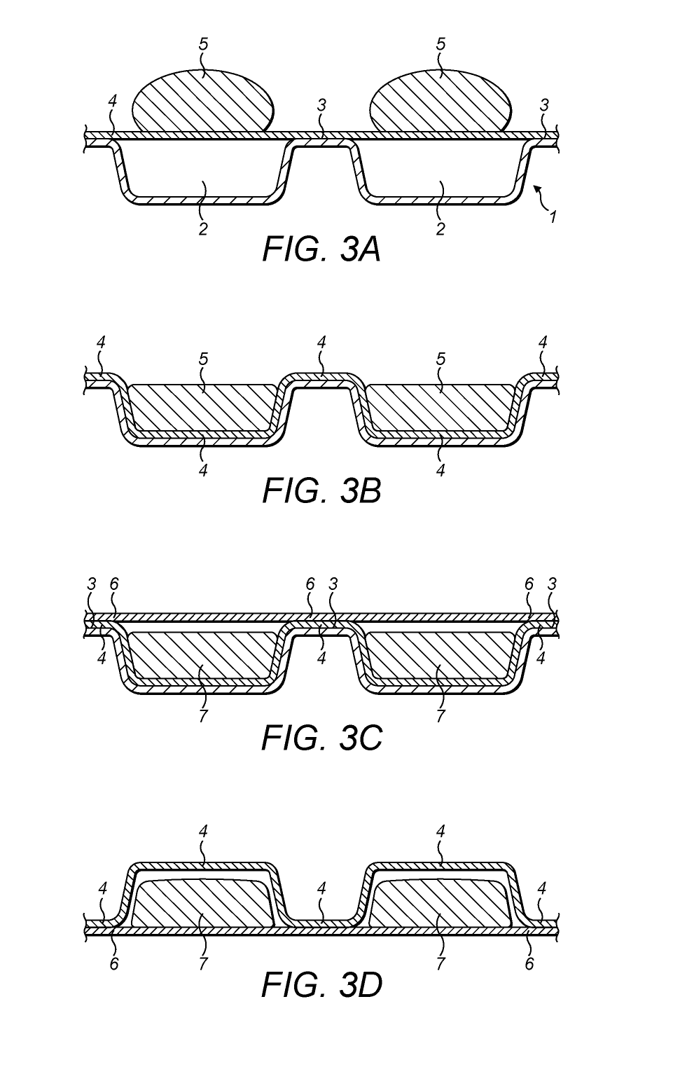

FIGS. 3A-3D schematically depict the sequential stages of a first embodiment of a method according to the invention and employing the tray as shown in FIGS. 1 and 2;

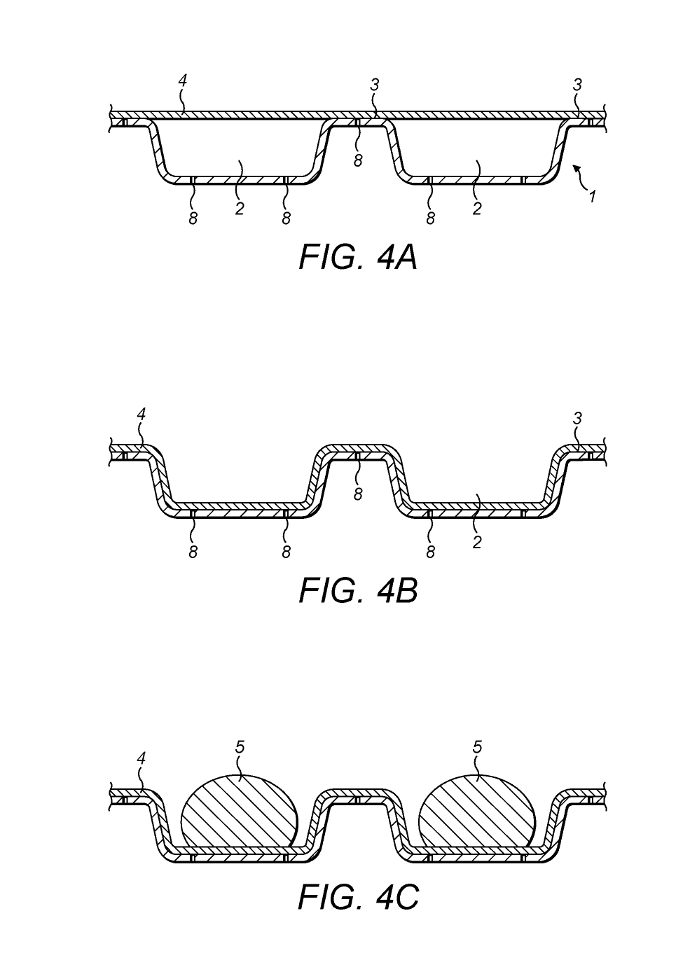

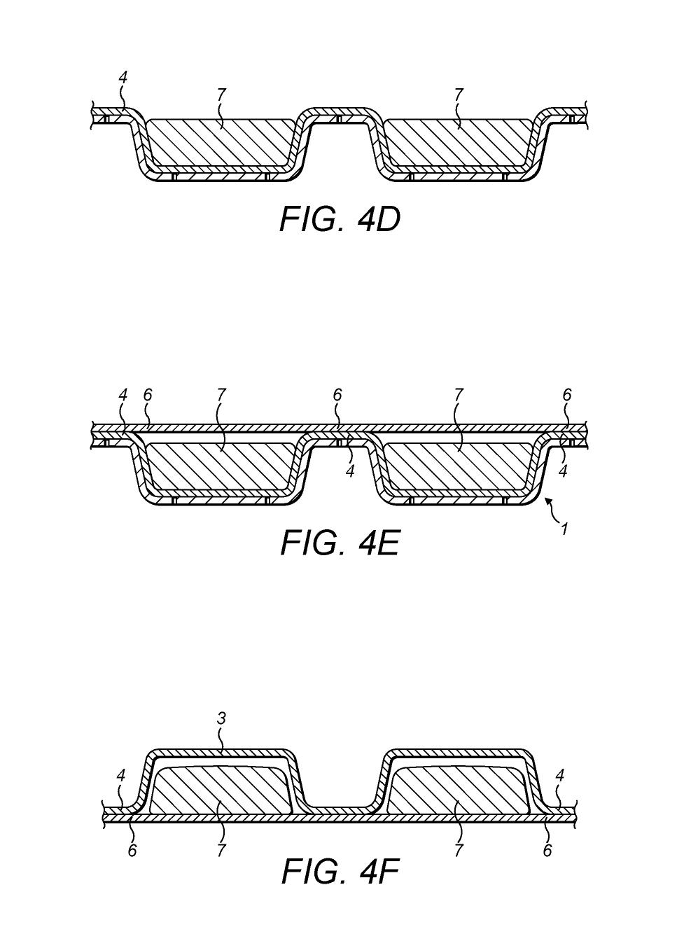

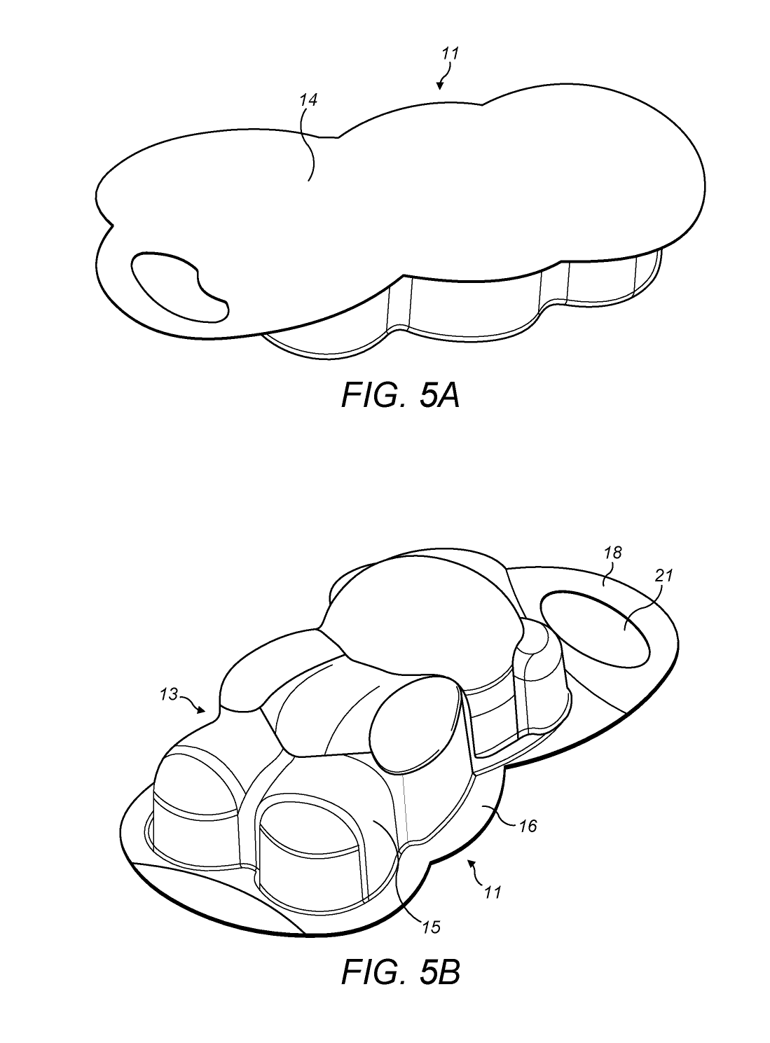

FIGS. 4A-4F schematically depict the sequential stages of a second embodiment of a method according to the invention and employing the tray as shown in FIGS. 1 and 2 modified to allow vacuum forming as set out below;

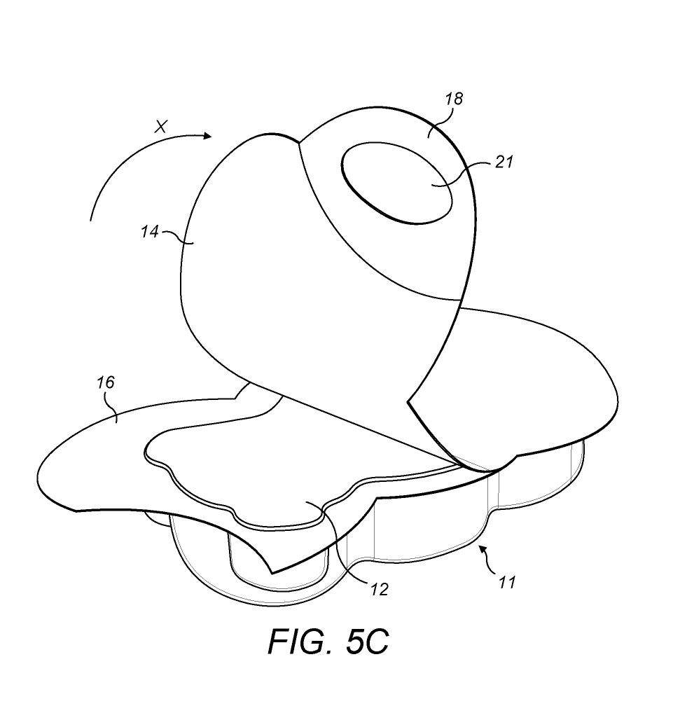

FIGS. 5A-5C schematically depict an exemplary embodiment of a packaged food item according to an embodiment the invention, which is a packaged food item 11 wherein the food item is a moulded biscuit.

FIGS. 1 and 2 each show a tray (1) suitable for use in an exemplary embodiment of a method according to an aspect of the invention. The tray 1 includes a plurality of moulds 2 present as recesses distributed in an array in a flat upper surface 3 of the tray 1.

The tray may be rigid in nature. The tray may be made of a rigid polymer or of a metal or alloy such as steel or an aluminium-based alloy, and may be provided with a non-adhesive or non-stick coating such as PTFE.

FIGS. 3A to 3D each show the stages in a process according to a first embodiment of a method according to the invention, using the tray 1 as shown in FIGS. 1 and 2. In each of the FIGS. 3A to 3D, a partial cross-sectional side view of the tray 1 is shown, depicting two of the moulds 2 side-by-side.

Turning to FIG. 3A, the tray 1 is shown with a first film 4 extending over the tray 1 and the moulds 2. Aliquots of dough 5 have been deposited onto the first film 4 extending over the mould 2. In FIG. 3A, the various components are shown room temperature, say from 20 to 30° C., and in this example, the dough 5 is not freely flowing at room temperature and the first film 4 is not deformed under the weight of the dough.

FIG. 3B shows the arrangement set out in FIG. 3A after the tray and the materials associated therewith have been placed in an oven, at a baking temperature between 150° C. and 250° C. The first film is brought to a temperature in excess of its glass temperature and so has deformed under the weight of the dough aliquots 5 and has been pressed into the inner face of the moulds to by the dough aliquots 5. The dough aliquots 5 have become a flowable at the baking temperature, prior to solidification by baking, and have filled the moulds 2.

Turning to FIG. 3C, following a sufficient baking time to ensure solidification of the dough 5 into a baked food item 7, in this case a biscuit, the tray 1 is removed from the oven and a second film 6 is extended over the tray 1, the moulds 2, the baked food item 7 and the first film 4, and is adhered to the first film 4 by pressing the second film 6 into the first film 4 against the flat upper surface 3 of the tray 1 as a support, so that an adhesive bond is formed between the first 4 and second 6 films. This adhesive bond may be supplemented by the application of heat to melt the films together, for instance by thermal welding, or, for instance, a pressure sensitive adhesive may be applied to the first film 4, and/or the second film 6, in the regions where adhesion between the films 4, 6 is required.

FIG. 3D shows a cross-sectional side-view through a multipack resulting from the method, which has been removed from the tray 1 and inverted onto the second film 6 as base.

FIGS. 4A to 4F show the stages in a process according to a second embodiment of a method according to the invention, using the tray 1 as shown in FIGS. 1 and 2, but with the tray 1 modified as modified tray 1′, including through-holes 8 passing between the lower and upper surfaces of the mould in order to permit vacuum forming using the tray as a vacuum forming template. These through-holes 8 may be of a small size, such as 1 mm² or less in cross sectional area. In each of the FIGS. 4A to 4F, a partial cross-sectional side view of the modified tray 1′ is shown, depicting two of the moulds 2 side-by-side.

Turning to FIG. 4A, the tray 1′ is shown with a first film 4 extending over the tray 1 and the moulds 2.

In FIG. 4B, the tray 1′ and first film 4 have been heated to exceed the glass transition temperature of the material making up the first film 4 and the first film 4 has been vacuum moulded to conform the shape of the upper surface of the tray 1′ and the inner faces of the moulds by extracting air through the through-holes 8 from the lower face of the tray 1′.

This initial heating step shown in relation to FIG. 4 takes place before adding the dough 5 to be baked.

In FIG. 4C, aliquots of dough 5 have been deposited onto the first film 4 which is now conformed to the inner faces of each respective mould 2.

In FIG. 4D, the tray 1′ has been placed in a baking oven at a temperature from 150° to 250° C. so that the dough 5 has become flowable and has filled the recesses of the moulds 2 and been baked into a biscuit 7.

Turning to FIG. 4E, following a sufficient baking time to ensure solidification of the dough 5 into a baked food item 7, in this case a biscuit, the tray 1′ is removed from the oven and a second film 6 is extended over the tray 1′, the moulds 2, the baked food item 7 and the first film 4, and is adhered to the first film 4 by pressing the second film 6 into the first film 4 against the flat upper surface 3 of the tray 1′, so that an adhesive bond is formed between the first 4 and second 6 films. This adhesive bond may be supplemented by the application of heat to melt the films together, for instance by thermal welding, or, for instance, a pressure sensitive adhesive may be applied to the first film 4, and/or the second film 6, in the regions where adhesion between the films 4, 6 is required.

FIG. 4F shows a cross-sectional side-view through a multipack resulting from the method, which has been removed from the tray 1′ and inverted onto the second film 6 as base.

FIGS. 5A to 5C schematically depict an exemplary embodiment of a packaged food item according to the invention, which is a packaged food item 11 wherein the food item is a moulded biscuit. A first preformed package part 13 includes a receptacle 15 surrounded partially by a flange 16. A second package part 14 is in the form of a flat sheet. The second package part 14 is also provided with a tab 18 which also includes a hole 21 adapted to accept a finger to assist with gripping an pulling the tab 18. The second package part 14 is attached to the flange 16 of the first package part 13 by means of a pressure sensitive adhesive in this embodiment, but it will be appreciated that other attaching or sealing means may be employed.

The inner face (not shown) of the receptacle 15 is adapted to conform to the shaped face of the biscuit 12 (lower face as shown in the FIGS. 5A, 5C). The first preformed package part 13 has the receptacle 15 in the form of a thin film so that the outer face of receptacle 15 also follows the shape of the inner face 19 such that the pattern on the shaped face of the moulded biscuit 12 is also shown on the outer face of the receptacle 15 of the packaged food item 11. This is shown in FIG. 5B. In this embodiment, the shaped surface of the biscuit is in the form of an animal.

In this exemplary embodiment, the biscuit been formed by baking in a mould by the process of the invention as set out hereinbefore. It will be understood that the biscuit 12 may be replaced in this embodiment by an alternative food item such as, for instance, a baked, moulded cake.

Although a few exemplary embodiments have been shown and described, it will be appreciated by those skilled in the art that various changes and modifications might be made without departing from the scope of the invention, as defined in the appended claims. For example, although reference has been made to a baked moulded biscuit in the Examples set out above, it will be understood that the baked moulded biscuit in the Examples may be substituted by a baked moulded cake or savoury biscuit and yet still be according to the invention. For instance, the dough may be a flowable batter at room temperature.

In summary, a packaged baked food item, and a method for forming it, are disclosed. A film is laid over a tray containing moulds and a portion of dough deposited onto the film over each mould. The dough is baked to form an item having a face moulded by the inner surface of the mould and with the film conformed to it. A second film is extended over the first film and the films are attached to each other to at least partially enclose the baked food item between the first and second films as a package. The first film may be pre-formed to the shape of the moulds prior to depositing the dough and baking. The method provides a means to facilitate packaging baked items, with a package mimicking the moulded shape of the underlying item, and may also be used to reduce the need for resurfacing of baking trays with non-stick layers.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims and drawings), and/or all of the steps of any method or process so disclosed, may be combined in any combination, except combinations where at least some of such features and/or steps are mutually exclusive.

Each feature disclosed in this specification (including any accompanying claims and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims and drawings), or to any novel one, or any novel combination, of the steps of any method or process so disclosed.

1. A method of forming a packaged baked food item, the method comprising:
providing a tray comprising a mould,
providing a first film extending over the tray and mould,
depositing an aliquot of dough onto the first film extending over the mould,
baking the aliquot of dough to provide a baked food item having a moulded face with the first film conformed thereto, wherein a portion of the dough forming the moulded face and the first film conform to an inner face of the mould, and
providing a second film extending over the baked food item and the first film, and attaching the second film to the first film to at least partially enclose the aliquot of dough between the first and second films as the packaged baked food item.

2. The method of claim 1 wherein the attaching of the second film to the first film to at least partially enclose the aliquot of dough between the first and second films is carried out prior to baking the aliquot of dough to provide the baked food item.

3. The method of claim 1 wherein the attaching of the second film to the first film to at least partially enclose the aliquot of dough between the first and second films is carried out after baking the aliquot of dough to provide the baked food item.

4. The method of claim 1, wherein the tray comprises a plurality of moulds and an aliquot of dough is deposited onto each mould for forming a plurality of packaged baked food items.

5. The method of claim 4 wherein the method provides a plurality of packaged baked food items in a multipack arrangement, wherein the multipack arrangement comprises the packaged baked food items mutually interconnected by flanges formed where the first and second films are attached together.

6. The method of claim 5, further comprising providing lines of weakness between the packaged food items whereby the packaged baked food items may be separated from the multipack arrangement.

7. The method of claim 5 further comprising separating the packaged baked food items from the multipack arrangement by forming cuts between the packaged baked food items along the interconnecting flanges.

8. The method of claim 1 wherein the tray comprises a flat upper surface having the mould as a recess therein.

9. The method of claim 8 wherein the first and second films are attached together by pressing the second film against the first film at loci where the first film is supported by the flat upper surface of the tray.

10. The method of claim 1 wherein the first and second films are peelably attached together.

11. The method of claim 1 wherein the first film is a thermoformable film which is deformable to conform to the inner face of the mould at the baking temperature.

12. The method of claim 11 wherein the thermoformable film has a glass transition temperature, and wherein the glass transition temperature is lower than a temperature at which baking the dough aliquot takes place.

13. The method of claim 12 wherein the glass transition temperature is in excess of 30° C., optionally in excess of 50° C.

14. The method of claim 1 wherein the first film is conformed to the inner face of the mould prior to depositing the aliquot of dough into the mould.

15. The method of claim 14 wherein the first film is conformed to the inner face of the mould by vacuum forming the prior to depositing the aliquot of dough into the mould.

16. The method of claim 1 wherein the baking temperature is from 150 to 200° C.

17. The method of claim 1 wherein the first film is a multilayer film comprising at least an inner layer in contact with the baked food item and an outer layer in contact with the tray, and wherein the inner layer is of a first material compatible with food contact at the baking temperature, and wherein the outer layer is of a second material suitable as an external barrier layer.

18. The method of claim 17 wherein the outer layer is a printed outer layer, printed prior to providing the first film extending over the tray and mould.

19. The method of claim 1 wherein the first film is adapted to shrink following baking of the dough, whereby the baked food item is tightly enclosed between the first and second films.

20. The method of claim 1 wherein the second film is a pre-printed film.

21. A packaged food item comprising a package having an enclosure adapted to hold the food item, wherein the package comprises:
a first package part comprising a receptacle having an opening comprising a material adapted to withstand a process for baking the food item and
a second package part attached or sealed to the first package part,
wherein the enclosure is at least partially formed via an association between the first and second package parts, and
wherein the receptacle includes an inner face adapted to conform to a shaped portion of a surface of the food item.

22. The packaged food item of claim 21 wherein the first package part is adapted to withstand a baking temperature in the range 150 to 250° C.

23. The packaged food item of claim 21 wherein the opening of the receptacle has a flange extending at least partially around the opening, and wherein the second package part is attached or sealed to the flange.

24. The packaged food item of claim 21 wherein the receptacle includes an outer face following the shape of the inner face.

25. The packaged food item of claim 21 wherein the first and/or second package parts are formed of a plastically deformable material whereby the package may be manually compacted for disposal following removal from the food item.

26. The packaged food item of claim 21 wherein the packaged food item is obtained or obtainable by the method comprising:
providing a tray comprising a mould,
providing a first film extending over the tray and mould,
depositing an aliquot of dough onto the first film extending over the mould,
baking the aliquot of dough to provide a baked food item having a moulded face with the first film conformed thereto, wherein a portion of the dough forming the moulded face and the first film conform to an inner face of the mould, and
providing a second film extending over the baked food item and the first film, and attaching the second film to the first film to at least partially enclose the aliquot of dough between the first and second films as the packaged baked food item, wherein the first package part is formed from the first film and the second package part is formed from the second film.

27. (canceled)
